(19) United States
(12) Patent Application Publication
(10) Pub. No.: US 2024/0260147 A1
(43) Pub. Date: Aug. 1, 2024

(54) COOKING APPARATUS AND METHOD FOR CONTROLLING SAME

(71) Applicant: LG Electronics Inc., Seoul (KR)

(72) Inventors: Soochan LEE, Seoul (KR); Jaekyung YANG, Seoul (KR); Hak Soon YANG, Seoul (KR); Hakjoo LIM, Seoul (KR); Suyong LEE, Seoul (KR)

(73) Assignee: LG Electronics Inc., Seoul (KR)

(21) Appl. No.: 18/290,425

(22) PCT Filed: Jun. 1, 2021
(86) PCT No.: PCT/KR2021/006770

§ 371 Date: Nov. 13, 2023

(30) Foreign Application Priority Data
May 12, 2021 (KR) 10-2021-0061464

(51) Int. Cl. H05B 6/64

(52) U.S. Cl. CPC H05B 6/6461

(57) ABSTRACT

A cooking apparatus and a method for controlling a cooking apparatus, the cooking apparatus determining whether or not food is overcooked regardless of the type and weight of the food to be cooked, on the basis of a change in the amount of carbon monoxide generated during cooking, and to minimize the possibility of an overcook determination error.

### TECHNICAL FIELD

The present disclosure relates to a cooking apparatus and a method for controlling the same that can determine overcooking regardless of the sort and weight of a food item to be cooked, and minimize the possibility of an overcooking determination error.

### BACKGROUND ART

Cooking apparatuses are installed in the kitchen and used to cook food items as the user wants. Cooking apparatuses can fall into different categories, based on a heat source or the type of a cooking apparatus, and the sort of fuel.

Cooking apparatuses can be categorized into open-type cooking apparatuses and sealed-type cooking apparatuses, depending on the shape of a space where a food item is placed. A sealed-type cooking apparatus comprises an oven, a microwave oven and the like, and an open-type cooking apparatus comprises a cooktop, a hob and the like.

In the sealed-type cooking apparatus, a space in which a food item is placed is shielded, and the shielded space is heated to cook the food item.

The sealed-type cooking apparatus is provided with a cooking compartment in which a food item is placed and which is shielded when a food item is cooked. The cooking compartment is a space in which a food item is substantially cooked. A heat source is provided inside or outside the cooking compartment, to heat the cooking compartment.

During cooking performed by a cooking apparatus, a cooking mode or cooking time is automatically set or manually set by the user, based on the sort and weight of a food item.

However, there are times when cooking of a food item ends even before cooking time set automatically or manually, i.e., when overcooking occurs.

In recent years, a means or a method of preventing or sensing overcooking have been applied to a cooking apparatus.

As a related art, a cooking apparatus configured to determine a cooking state by measuring an amount of air generated during baking is disclosed in U.S. Pat. No. 7,997,263 (prior art document 1).

The cooking apparatus of prior art document 1 has a configuration in which a fan is disposed at the upper end of an oven as a means of increasing a measured concentration of air to improve accuracy of measurement at a time of baking, and an amount of exhausted air increases by controlling a rotation speed of the fan.

However, since the configuration of the cooking apparatus disclosed in the prior art document is limited to a baking mode, the configuration can hardly be applied to another sort of food item or in another cooking mode.

Additionally, a configuration in relation to a method of determining overcooking is disclosed in KR Patent Publication No. 10-1997-0007109 (prior art document 2), and in the configuration, it is determined whether a current concentration of carbon monoxide reaches a reference concentration of carbon monoxide, set differently for each food item to be cooked, while overcooking is determined based on a concentration of carbon monoxide generated during cooking of a food item.

However, in terms of the configuration in prior art document 2, reference concentrations of carbon monoxide for all sorts of food items need to be set, and a concentration of carbon dioxide generated can vary depending on weight despite the same sort of food, and an overcooking determination error can occur due to noise that can be included in an output value of a gas sensor sensing a concentration of carbon monoxide.

### DESCRIPTION OF THE INVENTION

### Technical Problems

To solve the above-described technical problems of the related arts, the first objective of the present disclosure is to provide a cooking apparatus and a method for controlling the same that can determine overcooking regardless of the sort and weight of a food item to be cooked.

The second objective of the present disclosure is to provide a cooking apparatus and a method for controlling the same that can minimize noise included in an output value of a gas sensor measuring a concentration of carbon monoxide generated during cooking, and minimize a determination error caused by noise.

The third objective of the present disclosure is to provide a cooking apparatus and a method for controlling the same that can stop cooking immediately and inform the user about overcooking when overcooking occurs during cooking, ensuring significant improvement in user satisfaction and convenience.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

### Technical Solutions

According to the present disclosure, a cooking apparatus comprises a cavity configured to have a cooking compartment of a food item, therein, a heating part configured to generate heat to be supplied to the cooking compartment, a gas sensor configured to sense gas generated in the cooking compartment, and a controller configured to supply power to the heating part and to operate the heating part, the controller performs a maximum generation determination step of determining whether an amount of the gas generated reaches a maximum value after the heating part operates, a minimum generation determination step of determining whether an amount of the gas generated reaches a minimum value after the maximum generation determination step, and a cooking completion determination step of determining the food item is cooked completely, when it is determined that the amount of the gas generated reaches the minimum value in the minimum generation determination step, and the gas is carbon monoxide. Thus, it can be determined or judged whether a food item is cooked completely or overcooked, regardless of the sort of a food item to be cooked.

The controller performs a heating part operation stop step of stopping an operation of the heating part, when determining that the food item is cooked completely in the cooking completion determination step.

The maximum generation determination step comprises a concentration value calculation step of receiving an output signal from the gas sensor, and based on the output signal received, calculating a concentration value of the gas.

The maximum generation determination step further comprises a first sum calculation step of adding concentration values that are calculated while first time is elapsed after a time point when the heating part operates, and calculating a first sum, a second sum calculation step of adding concentration values that are calculated while second time is elapsed after the first sum calculation step, and calculating a second sum, and a first sum and second sum comparison step of comparing the first sum and the second sum.

The minimum generation determination step comprises when it is determined that the first sum is greater than or the same as the second sum in the first sum and second sum comparison step, a third sum calculation step of adding concentration values that are calculated while third time is elapsed after the second sum calculation step, and calculating a third sum, a fourth sum calculation step of adding concentration values that are calculated while fourth time is elapsed after the third sum calculation step, and calculating a fourth sum, and a third sum and fourth sum comparison step of comparing the third sum and the fourth sum.

Additionally, when determining that the fourth sum is greater than or the same as the third sum in the third sum and fourth sum comparison step, the controller determines that the food item is cooked completely.

Further, the first time is the same as the second time.

Further, the third time is the same as the fourth time.

Further, the third time and the fourth time are less than the first time and the second time.

Further, the first time and the second time are 2 to 3 minutes, and the third time and the fourth time are 1 to 2 minutes.

Further, concentration values added in the first sum calculation step and concentration vales added in the second sum calculation step are calculated respectively by adding concentration values sampled in a first sampling cycle that is less than the first time and the second time.

Further, concentration values added in the third sum calculation step and concentration vales added in the fourth sum calculation step are calculated respectively by adding concentration values sampled in a second sampling cycle that is less than the third time and the fourth time.

Further, a first sampling cycle is greater than the second sampling cycle.

Furthermore, the first sampling cycle is 5 to 10 seconds, and the second sampling cycle is 3 to 5 seconds.

According to the present disclosure, a method for controlling a cooking apparatus that comprises a cavity configured to have a cooking compartment of a food item, therein, a heating part configured to generate heat to be supplied to the cooking compartment, and a gas sensor configured to sense gas generated in the cooking compartment comprises a maximum generation determination step of determining whether an amount of the gas generated reaches a maximum value after the heating part operates, a minimum generation determination step of determining whether an amount of the gas generated reaches a minimum value after the maximum generation determination step, and a cooking completion determination step of determining the food item is cooked completely when it is determined that the amount of the gas generated reaches the minimum value in the minimum generation determination step, and the gas is carbon monoxide.

Additionally, the method further comprises a heating part operation stop step of stopping an operation of the heating part, when it is determined that the food item is cooked completely in the cooking completion determination step.

Further, the maximum generation determination step comprises a concentration value calculation step of receiving an output signal from the gas sensor, and based on the output signal received, calculating a concentration value of the gas.

Further, the maximum generation determination step further comprises a first sum calculation step of adding concentration values that are calculated while first time is elapsed after a time point when the heating part operates, and calculating a first sum, a second sum calculation step of adding concentration values that are calculated while second time is elapsed after the first sum calculation step, and calculating a second sum, and a first sum and second sum comparison step of comparing the first sum and the second sum.

Further, the minimum generation determination step comprises when it is determined that the first sum is greater than or the same as the second sum in the first sum and second sum comparison step, a third sum calculation step of adding concentration values that are calculated while third time is elapsed after the second sum calculation step, and calculating a third sum, a fourth sum calculation step of adding concentration values that are calculated while fourth time is elapsed after the third sum calculation step, and calculating a fourth sum, and a third sum and fourth sum comparison step of comparing the third sum and the fourth sum.

Furthermore, when it is determined that the fourth sum is greater than or the same as the third sum in the third sum and fourth sum comparison step, it is determined that the food item is cooked completely.

### Advantageous Effects

A cooking apparatus and a method for controlling the same according to the present disclosure can determine overcooking regardless of the sort and weight of a food item to be cooked.

A cooking apparatus and a method for controlling the same according to the present disclosure can minimize noise included in an output value of a gas sensor measuring a concentration of carbon monoxide generated during cooking, and minimize a determination error caused by noise.

A cooking apparatus and a method for controlling the same according to the present disclosure can stop cooking immediately and inform the user about overcooking when overcooking occurs during cooking, ensuring significant improvement in user satisfaction and convenience.

Specific effects are described along with the above-described effects in the section of detailed description.

### BRIEF DESCRIPTION OF THE DRAWINGS

FIG. 1 is a front perspective view showing a cooking apparatus according to the present disclosure.

FIG. 2 is a rear perspective showing the cooking apparatus according to the present disclosure.

FIG. 3 is a side view showing the cooking apparatus illustrated in FIG. 1.

FIGS. 4 and 5 are partially enlarged views of FIG. 4.

FIG. 6 is a functional block diagram for describing a controller of a cooking apparatus of one embodiment.

FIGS. 7 to 10 are graphs showing concentrations of carbon monoxide of each food item, which is measured based on passage of time.

FIGS. 11 to 13 are flowcharts showing a method for controlling the cooking apparatus of one embodiment.

### DETAILED DESCRIPTION OF EXEMPLARY EMBODIMENTS

The above-described aspects, features and advantages are specifically described hereinafter with reference to accompanying drawings such that one having ordinary skill in the art to which the subject matter of the present disclosure pertains can embody the technical spirit of the disclosure easily. In the disclosure, detailed description of known technologies in relation to the subject matter of the disclosure is omitted if it is deemed to make the gist of the disclosure unnecessarily vague. Hereinafter, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components are not to be limited by the terms. Certainly, a first component can be a second component, unless stated to the contrary.

Throughout the disclosure, each component can be provided a single one or a plurality of ones, unless stated to the contrary.

When any one component is described as being “in the upper portion (or the lower portion)” or “on (or under)” another component, any one component can be directly on (or under) another component, and an additional component can be interposed between the two components.

When any one component is described as being “connected”, “coupled” or “connected” to another component, any one component can be directly connected or coupled to another component, but an additional component can be “interposed” between the two components or the two components can be “connected”, “coupled” or “connected” by an additional component.

In the disclosure, singular forms include plural forms as well, unless explicitly indicated otherwise. In the disclosure, the terms “comprised of”, “comprise”, and the like do not imply necessarily including stated components or stated steps and imply excluding some of the stated components or stated steps or including additional components or additional steps.

In the disclosure, singular forms include plural forms as well, unless explicitly indicated otherwise. In the disclosure, the terms “comprised of”, “comprise”, and the like do not imply necessarily including stated components or stated steps and imply excluding some of the stated components or stated steps or including additional components or additional steps.

Throughout the disclosure, the terms “A and/or B” as used herein can denote A, B or A and B, and the terms “C to D” can denote C or greater and D or less, unless stated to the contrary.

Hereinafter, the present invention is described with reference to drawings where the configuration of a cooking apparatus 1 in the embodiments of the present disclosure is illustrated.

### [Entire Structure of Cooking Apparatus]

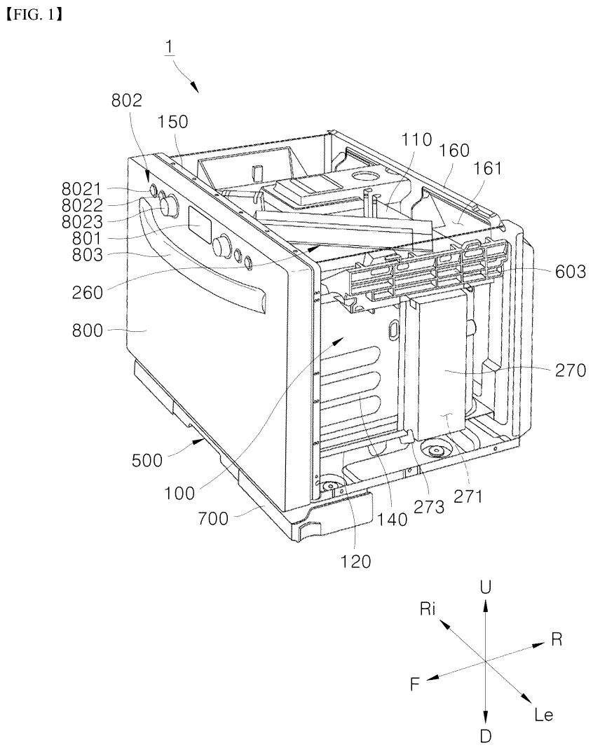

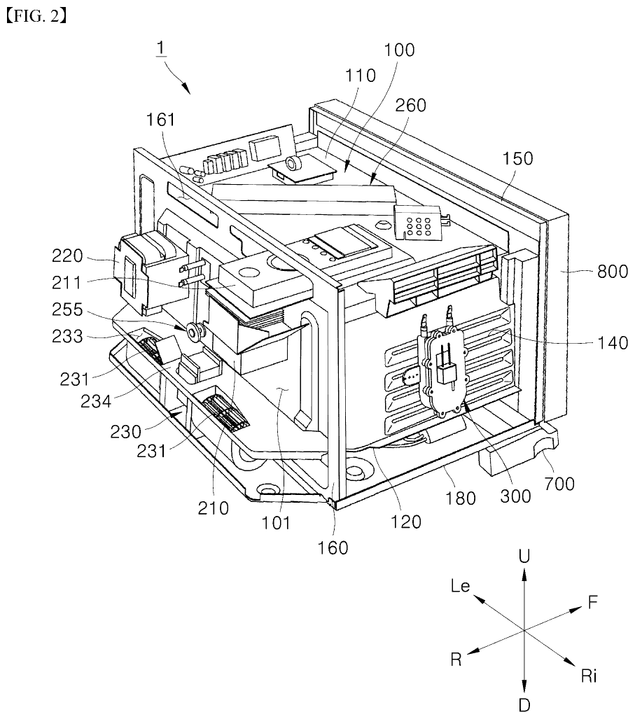

FIG. 1 is a front perspective view showing a cooking apparatus 1 in one embodiment of the present disclosure, and FIG. 2 is a rear perspective showing the cooking apparatus 1 in one embodiment of the present disclosure.

Referring to FIGS. 1 and 2, the cooking apparatus 1 is provided with a cavity 100 the front surface of which is open.

The cavity 100 has a cooking compartment 101 therein, and the cooking compartment 101 is a place where food is cooked.

The cavity 100 may comprise an upper plate 110, a bottom plate 120, a rear plate and a pair of side plates 140.

The upper plate 110 and the bottom plate 120 respectively form the upper surface and the lower surface of the cavity 100. Additionally, the rear plate forms the rear surface of the cavity 100, and the pair of side plates 140 forms both lateral surfaces of the cavity 100.

Though not illustrated, an outer case forming the exterior of the cooking apparatus may shield the exteriors of the upper plate 110 and the side plate 140. Accordingly, the outer case may be formed to have a longitudinal cross section of an approximate L shape.

Substantially, the cavity 100 may be shaped into a polyhedron the front surface of which is open. Additionally, substantially, the upper plate 110 and the bottom plate 120 respectively form the ceiling and the bottom surface of the cooking compartment 101. Further, the rear plate and the pair of side plates 140 may form the rear surface and both lateral surfaces of the cooking compartment 101.

The upper plate 110 may have a radiation opening (not illustrated) and a porous part (not illustrated). The radiation opening serves as an entrance through which microwaves generated by a magnetron 210 described hereinafter is radiated into the cooking compartment 101. The porous part (not illustrated) transfers energy, i.e., light and heat, of a halogen heater 260 described hereinafter into the cooking compartment 101.

The rear plate has a plurality of suction holes and discharge holes. The suction hole allows air to be suctioned from the inside of the cooking compartment 101 into a convection chamber described hereinafter, and the discharge hole allows air to be discharged from the inside of the convection chamber into the cooking compartment 101. That is, the suction hole and the discharge hole may allow the cooking compartment 101 and the convection chamber to communicate with each other.

Additionally, any one of the pair of side plates 140 may have a cooking compartment exhaust hole 1411. For example, the cooking compartment exhaust hole 1411, as illustrated in FIG. 1, may be formed on a left side plate 141. The cooking compartment exhaust hole 1411 serves as an outlet through which air supplied into the cooking compartment 101 together with microwaves through the radiation opening is discharged out of the cooking compartment 101. The cooking compartment exhaust hole 1411 may communicate with an exhaust duct 270 described hereinafter.

Additionally, the other of the pair of side plates 140 may has a steam spray hole (not illustrated). For example, the steam spray hole, as illustrated in FIG. 2, may be formed at a right side plate 142. The steam spray hole is to supply steam generated by the steam generator 300 into the cooking compartment 101.

Additionally, a front plate 150 and a back plate 160 may be respectively provided at the front end of the cavity 100 and on the rear surface of the cavity 100. Substantially, the front plate 150 ( ) may be fixed to the front ends of the upper plate 110, the bottom plate 120 and the side plates.

A portion of the front surface of the back plate 160 may be fixed to the rear surface of the rear plate. The front plate 150 and the back plate 160 may be formed to extend further to the outside of the cavity 100 in an up-down direction (U-D direction) and a left-right direction (Le-Ri direction).

The back plate 160 extending in the upward direction of the upper plate 110 may have a communication opening 161 in the upper portion thereof. The communication opening 161 may allow the upper portion of the cavity 100 and an electronic component compartment described hereinafter to communicate with each other.

Additionally, a back cover 170 may be provided on the rear surface of the back plate 160.

The back cover 170 may be fixed to the rear surface of the back plate 160 to shield at least a portion of the back plate 160 comprising the communication opening 161.

The back plate 160 may have a plurality of suction openings 171, respectively in the lower portions of both lateral surfaces thereof. The suction opening 171 may serve as an inlet through which air is suctioned into the cooking apparatus 1, based on the driving of a cooling fan assembly 230 described hereinafter.

Further, a base plate 180 may be provided in the lower portion of the cavity 100. The upper surface of the base plate 180 may be fixed to the lower ends of the front plate 150, the back plate 160 and the back cover 170.

An exhaust opening (not illustrated) may be formed in the base plate 180 that is spaced forward apart from the lower end of the back plate 160 by a predetermined distance. The exhaust opening may serve as an outlet through which air having flown in the cooking apparatus 1, based on the driving of the cooling fan assembly 230, is discharged outward through the exhaust duct 270, while forming an air current F.

For example, the exhaust opening may have a quadrangle shape that is entirely elongated in the left-right direction. Additionally, condensed water, where steam included in air current F discharged through the cooking compartment exhaust hole 1411 is condensed and formed, may be discharged outward through the exhaust opening. Further, a leg may be provided at the edges of the bottom surface of the base plate 180.

An electronic component compartment may be formed among the rear surface of the front plate 150, the front surface of the back cover 170 and the upper surface of the base plate 180. A plurality of electronic components and a circuit board 603 may be installed in the electronic component compartment.

Specifically, a magnetron 210 may be installed in the electronic component compartment. The magnetron 210 oscillates microwaves that is radiated into the cooking compartment 101.

Additionally, a high voltage transformer 220 may be installed in the electronic component compartment. The high voltage transformer 220 may supply high voltage current to the magnetron 210, and constitute a part of power supplier 220.

Further, a wave guide 211 for guiding microwaves oscillated by the magnetron 210 into the cooking compartment 101 may be installed on the upper surface of the cavity 100, i.e., the upper pate 110.

Furthermore, a cooling fan assembly 230 may be installed in the electronic component compartment corresponding to the downward direction of the magnetron 210 and the high voltage transformer 220. The cooling fan assembly 230 may form air current F of air circulating in the cooking compartment 101.

For example, the cooling fan assembly 230 may comprise at least one fan motor 232 driving two cooling fans 231 and a cooling fan 231. A sirocco fan suctioning air in a rotation axis direction and discharging air in a circumferential direction may be applied as the cooling fan 231. The cooling fan 231 is not limited to a sirocco fan in the present disclosure, but the cooling fan 231 applying a sirocco fan is described, for example.

An air barrier 231 for preventing air discharged from the cooling fan 231 from being suction again into the cooling fan 231 may be installed in the electronic component compartment. The air barrier 231 substantially may partition the electronic component compartment into an area where electronic components including the magnetron 210 and the high voltage transformer 220 are installed, and an area where the cooling fan 231 is installed. Additionally, the air barrier 231 may have a discharge opening 233 corresponding to an exhaust part of the cooling fan assembly 230.

Further, the circuit board 603 on which a plurality of circuit components sit may be installed in the electronic component compartment. For example, the circuit board 603, as illustrated in FIG. 1, may be installed at the upper side of the exhaust duct 270 as the upper side of the left side plate 141. The position of the circuit board 603 is not limited in the present disclosure, but the circuit board 603 disposed at the upper side of the exhaust duct 270 is described as an example.

The plurality of circuit components sitting on the circuit board 603 may comprise a central processing unit that may be referred to as a micom, a microcontroller or a microprocessor. The central processing unit may be referred to as a controller 600 as described hereinafter.

Additionally, the plurality of circuit components sitting on the circuit board 603 may comprise a communication unit (not illustrated). The communication unit may access a user mobile device 2 and the like, in a wireless manner, through a communication module. Accordingly, the user may see information on an operation state of the cooking apparatus 1 or a cooking state of a food item and the like. In particular, the controller 600 may immediately transmit an alarm message and the like to the mobile device 2 through the communication module, when a food item is cooked completely or overcooked, as described hereinafter. Thus, user convenience may improve significantly.

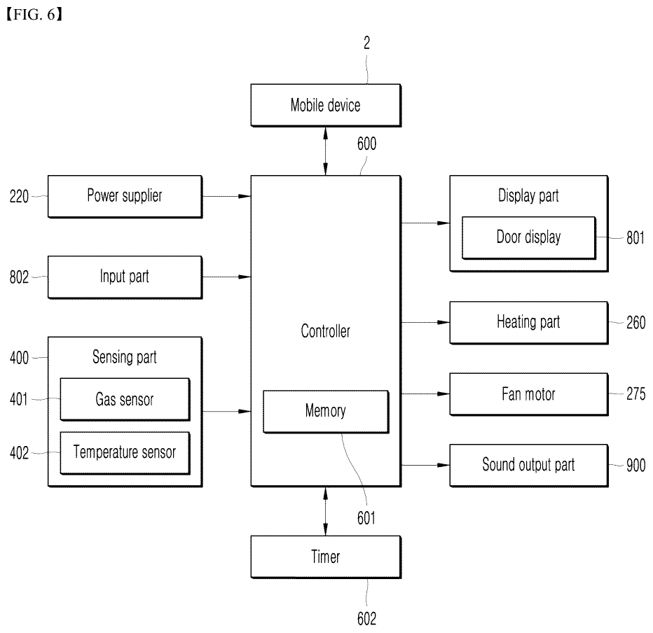

Further, a sound output part (900 in FIG. 6) may be added in the electronic component compartment as a means of transferring a message notifying an operation state of the cooking apparatus 1 or completion of cooking to the user, through a voice alarm or a sound alarm.

The sound output part 900 may be provided in the form of a buzzer that can generate a sound alarm, and in the form of a speaker that can generate a voice alarm. Any well-known means in the art can be applied as a configuration in relation to the sound output part 900 comprising a buzzer and a speaker and the like, and detailed description in relation to this is omitted.

Further, an upper heater (not illustrated) may be installed in the upper partition of the cooking compartment 101. The upper heater may provide heat for radiantly heating a food item in the cooking compartment 101. For example, a sheath heater may be used as the upper heater.

Additionally, a convection heater (not illustrated) and a convection fan (not illustrated) may be installed in the convection chamber. The convection heater provides heat for convection-heating a food item in the cooking compartment 101. The convention fan forms a flow of air circulating in the cooking compartment 101 and the convection chamber. Specifically, as the convention fan operates, air passes through the suction hole and the discharge hole and circulates in the cooking compartment 101 and the convection chamber. Accordingly, heat of the convection heater may be convected to the cooking compartment 101 through air, by the convection fan. Further, the convection fan may operate apart from an operation of the convection heater, depending on whether the steam generator 300 operates.

Additionally, a convection motor 255 may be installed in the electronic component compartment. The convection motor 255 provides a rotation driving force for operating the convection fan.

Further, the halogen heater 260 may be installed in the electronic component compartment. The halogen heater 260 may be fixed to the upper plate 110, and provide light and heat into the cooking compartment 101 through the porous part. The halogen heater 260 may be shielded by a reflector and a heater cover. Furthermore, a lamp (not illustrated) for lighting the inside of the cooking compartment 101 may be installed at the upper pate 110.

Additionally, a guide duct 280 may be provided on the bottom surface of the base plate 180. The guide duct 280 guides air current F of air discharged out of the cooking apparatus 1 through the exhaust opening in a predetermined direction. In the illustrated embodiment, the guide duct 280 may have a polyhedron with an upper surface and both lateral surfaces that are approximately open, and accordingly, air discharged through the exhaust opening may be guide to both sides of the cooking apparatus 1.

Further, condensed water, which is condensed while air discharged out of the cooking compartment 101 flows in the exhaust duct 270, may be collected at the guide duct 280. The condensed water collected at the guide duct 280 may be vaporized by air discharged through the exhaust opening, or flow downward through the end portions of both sides of the guide duct 280.

Further, the steam generator 300 may be installed at the right side plate 142 corresponding to the opposite side of the exhaust duct 270. The steam generator 300 generates steal that is supplied to the cooking compartment 101.

Further, a condensed water tray 700 may be installed in the front end portion of the bottom surface of the base plate 180. The condensed water tray 700 is used to collect condensed water that is discharged to a space between the front surface of the cavity 100, i.e., the front surface of the front plate 150, and the back surface of a door 800 described hereinafter. Preferably, the front surface of the condensed water tray 700 is disposed on the same flat surface as the front surface of the door 800, in the state where the door 800 shields the cooking compartment 101.

Additionally, the door 800 disposed at the front of the cavity 100 selectively opens and closes the cooking compartment 101.

The door 800 may be rotatably provided at the front of the cavity 100, to open and close the cooking compartment 101 selectively. For example, the door 800 may open and close the cooking compartment 101 in a pull-down manner, such that the upper end of the door 800 rotates around the lower end of the door 800 in the up-down direction (U-D direction).

In the illustrated embodiment, the door 800 covers the front surfaces of the cavity 100 and the front plate 150 entirely, but is described as an example. That is, the door 800 may be configured to cover the front surface of the cavity 100 only.

The door 800 may be shaped into a cuboid that has a predetermined thickness entirely, and a handle 803 may be installed on the front surface of the door 800 and gripped by the user when the user wants to rotate the door 800.

A power button 8021, a selection button 8022 and a knob 8032 that constitute an input part 802 into which a control instruction of the user is input may be provided in the upper portion of the front surface of the door 800. Additionally, a display part 801 displaying an operation state of the cooking apparatus 1 may be provided in a position near the power button 8021, the selection button 8022 and the knob 8032. Accordingly, the user may intuitively check the state where a user control instruction is input and the state where cooking proceeds, through the selection button 8022 or the knob 8023.

### [Detailed Configuration of Exhaust Duct and Gas Sensor]

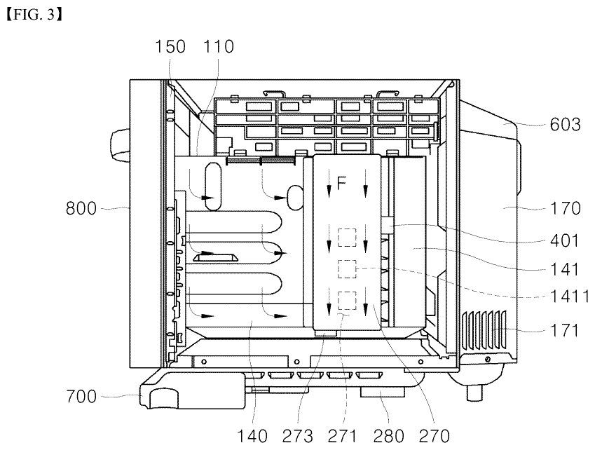

The cooking apparatus 1 of one embodiment, as illustrated in FIG. 3, may comprise the exhaust duct 270 that is provided outside the left side plate 141 having the cooking compartment exhaust hole 1411.

The exhaust duct 270 guides air discharged through the cooking compartment exhaust hole 1411, i.e., air discharged out of the cooking compartment 101 after circulating in the cooking compartment 101, to the exhaust opening. To smoothly guide the discharged air, the exhaust duct 270 may be installed on the outer surface of the left side plate 141 and shields the cooking compartment exhaust hole 1411 entirely.

To this end, the exhaust duct 270 may be shaped into a polyhedron which has a hollow inside and one surface of which is open.

Specifically, in the illustrated embodiment, the exhaust duct 270 may be shaped into a cuboid the right surface of which is open. That is, a left surface 272, a front surface 274, a rear surface 275 and an upper surface 276 of the exhaust duct 270 may be blocked entirely, and a lower surface 277 of the exhaust duct 270 may be partially open. The partially open portion of the lower surface 277 serves as a discharge outlet 271.

Additionally, a flange-shaped fixation surface 278 for a fastening to the left side plate 141 is provided on the front surface 274 and the rear surface 275 in such a way that the fixation surface 278 extends in the front-rear direction ((F-R direction).

Further, condensed water where steam included in air discharged out of the cooking compartment 101 is condensed may be formed at the exhaust duct 270. To discharge the condensed water, the exhaust duct 270 may be formed in such a way that a flow cross section, in which air discharged out of the cooking compartment 101 flows, decreases. For example, a portion of the discharge outlet 271 is shielded, substantially producing the effect of reducing the flow cross section. In the illustrated embodiment, a shielding rib 273 shielding a portion of the discharge outlet 271 may be provided at the exhaust duct 270. The shielding rib 273 may extend downward at a slat toward the exhaust opening from one side of the exhaust duct 270 corresponding to the upper portion of the discharge outlet 271.

Additionally, a gas sensor 401 measuring a concentration of a specific gas included in air discharged from the cooking compartment 101 may be installed at the exhaust duct 270 of the cooking apparatus 1 of one embodiment.

The gas sensor 401 connects to the above-described controller 600 in wired and wireless manners, and converts data on concentrations of a gas into an electric signal and transmits the electric signal to the controller 600.

The gas sensor 401 may become one component of a sensing part 400 for monitoring a cooking state and an operation state in the cooking compartment 101.

As described above, the objective of the present disclosure is to provide a means of indirectly checking an overcook state of a food item, based an amount of a specific gas that is generated to the cooking compartment 101.

At this time, carbon monoxide may be a specific gas, and an amount of carbon monoxide generated from the cooking compartment 101 may be indirectly estimated based on a concentration of carbon monoxide measured by the gas sensor 401.

The configuration of a control method using the gas sensor 401 is described hereinafter, with reference to FIG. 1 to FIG. 7.

A catalytic combustible flammable method, a semiconductor method, a double membrane Galvanic electronic method, a double membrane electrode method, a constant potential electrolysis method, a hydrogen salt ionization method (FID method) and the like may be applied to the gas sensor 401. However, the gas sensor in the present disclosure is not limited, and in addition to them, any means of outputting data on concentrations of carbon monoxide electrically may be unlimitedly applied to the gas sensor in the present disclosure. For example, an embodiment in which a semiconductor-type gas sensor 401 is applied is described hereinafter.

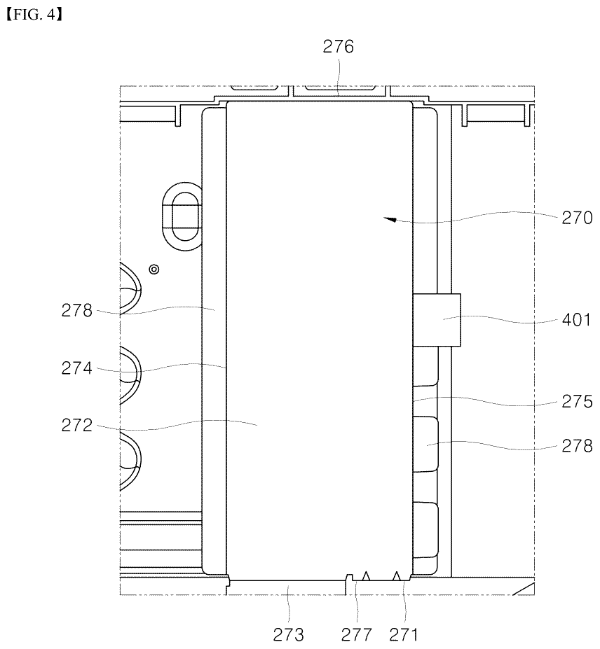

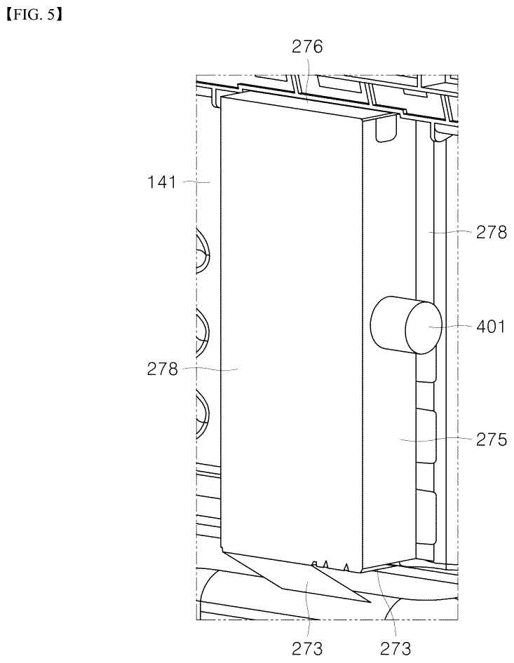

As illustrated in FIGS. 4 and 5, to suppress an increase in the left-right size of the cooking apparatus 1, the gas sensor 401 may be installed in a way that penetrates the front surface 274 or the rear surface 275 of the exhaust duct 270.

Additionally, at least a sensing surface of the gas sensor 401 may be disposed in the exhaust duct 270, to be exposed to air flowing in the exhaust duct 270.

Additionally, the gas sensor 401 is greatly affected by heat and electromagnetic waves generated by a heating part such as the above-described halogen heater 260 and the like. That is, a surrounding temperature of the gas sensor 401 needs to remain at 70° C. or less, to minimize noise of an output value, caused by temperature, and minimize damage to the gas sensor 401 caused by heat.

Accordingly, the gas sensor 401 is installed preferably in a middle position of the rear surface 275 of the exhaust duct 270, as described above, to minimize the effect of heat and electromagnetic waves from the heating part.

It experimentally turned out that a surrounding temperature of the position is maintained at 70 to 75° C., even in an operation mode where temperature in the cooking compartment 101 remains at the highest level.

Additionally, a temperature sensor may be further included as another component of the sensing part 400. The temperature sensor may be installed inside or outside the cavity 100, to measure temperature of the cooking compartment 101 directly and indirectly. Like the gas sensor 401, any means of outputting data on temperature as an electric signal may be unlimitedly applied to the temperature sensor.

### [Method for Controlling a Cooking Apparatus]

Hereinafter, the configuration of a controller 600 of the cooking apparatus 1 according to the present disclosure is described.

As illustrated in FIG. 6, the cooking apparatus 1 may comprise a controller 600 for controlling each functional component.

The controller 600, as described above, may sit on the circuit board 603, and as is publicly known in the art, may be provided in a variety of forms such as a microcontroller, a micom, or a microprocessor and the like.

The controller 600 electrically connects to a power supplier comprising the above-described high voltage transformer 220 and the like. Power input from an external power source is converted through the poser supplier, and supplied to the controller 600 and the fan motor 232 of the cooling fan assembly 230 and the like.

Additionally, the controller 600 electrically connects to the input part 802. The input part 802, as described above, may comprise a power button 8021, a selection button 8022 and a knob 8023 and the like. The controller 600 may receive a control instruction signal, i.e., a power-ON signal of the user, a cooking mode selection signal of the user and the like, through the input part 802.

Further, the controller 600 electrically connects to a memory 601. The controller 600 calls a driving condition of each cooking mode and the like that is stored in advance in the memory 601, and with the driving condition, generates a control signal for controlling a heating part and the like. Further, temperature conditions and time conditions of each cooking mode, and concentration values of carbon monoxide calculated with the gas sensor 401, and the like may be stored in the memory 601, as described hereinafter.

Further, the controller 600 electrically connects to a door display constituting the display part 801 and the sound output part 900. The controller 600 may display information on an operation state, operation time and the like of the cooking apparatus 1 and information as to whether cooking is completed, and the like, through the door display, and may control the sound output part 900 to output an operation state of the cooking apparatus 1 or an alarm message as a voice or a sound through the above-described sound output part 900 such as a buzzer or a speaker and the like.

Further, the controller 600 electrically connects to a timer 602. The controller 600 may calculate an operation initiation time point of the cooking apparatus 1 and elapsed time after an operation initiation of the cooking apparatus 1 and the like, through the timer 602. Information on the operation initiation time point and the elapsed time and the like may be temporarily stored in the memory 601.

Furthermore, the controller 600 electrically connects to the sensing part 400 comprising the gas sensor 401, the temperature sensor and the like. An output signal of the gas sensor 401 and an output signal of the temperature sensor may be respectively transmitted to the controller 600 as an electric signal or data, and the controller 600 converts the electric signal received to monitor a concentration of gas such as carbon monoxide and the like, and temperature in the cooking compartment 101 and the like.

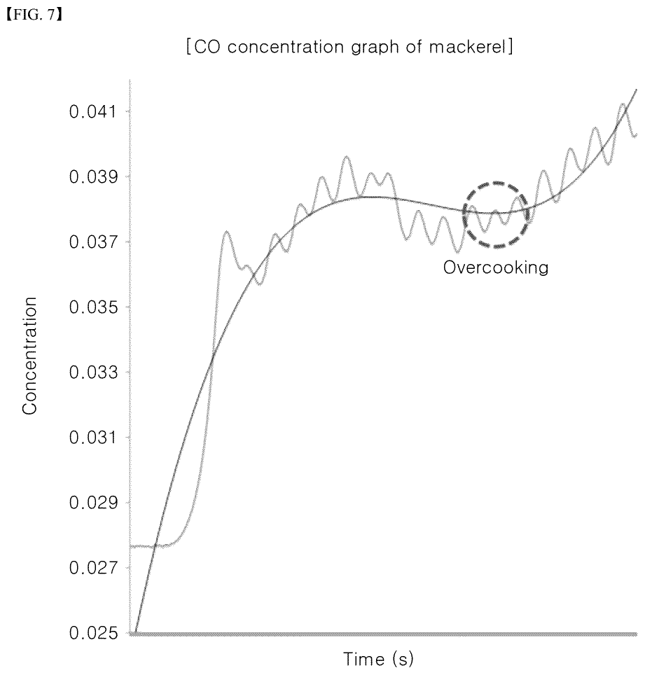

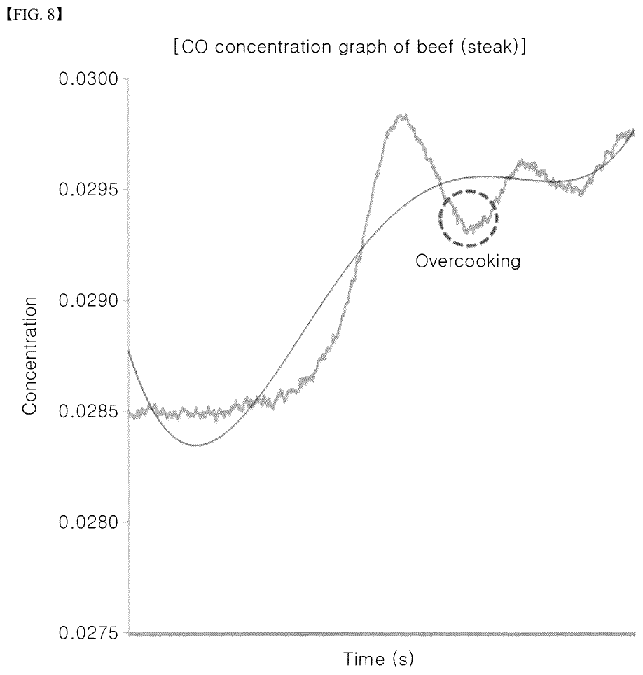

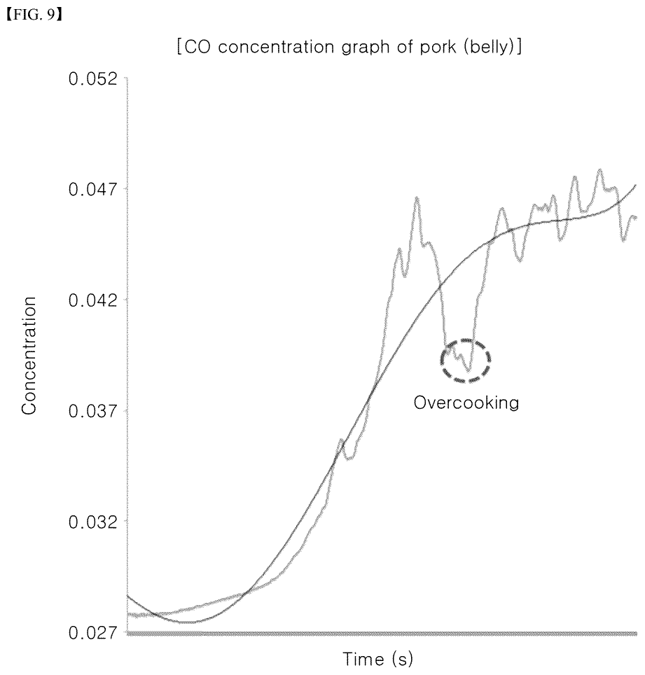

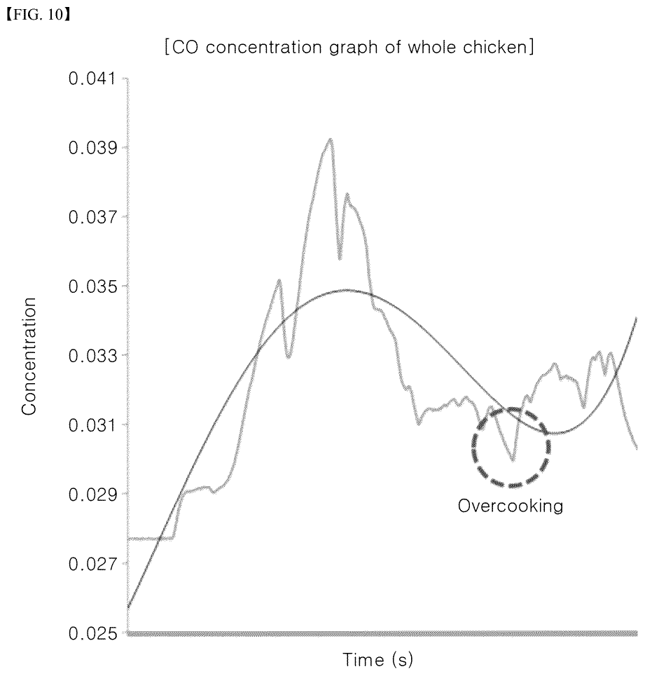

Hereinafter, described is the configuration of the method for controlling a cooking apparatus 1, in particular, the configuration of the control method for determining whether a food item is cooked completely or overcooked, according to the present disclosure, with reference to FIGS. 7 to 13.

As described above, the objective of the present disclosure is to provide a means of automatically determining whether a food item being cooked is cooked completely or overcooked even before preset cooking time is over to cook the food item in an optimal state. That is, the cooking apparatus may be configured to sense overcooking of a food item may be sensed without additional settings or manipulations of the user, regardless of the sort of the food item being cooked.

The cooking apparatus 1 according to the present disclosure uses an amount of gas generated during cooking of a food item as a means of determining whether the food item is overcooked, regardless of the sort of the food item.

Ordinarily, a variety of gases and moisture are generated during cooking. For example, carbon dioxide, carbon monoxide and other gases producing a variety of smells may be generated.

In the present disclosure, overcooking may be determined by using an amount of carbon monoxide that is commonly generated while various sorts of food items are cooked.

In particular, amounts of carbon monoxide generated vary depending on the sort of a food item being cooked and a cooking mode.

An experiment revealed that overcooking tends to occur at a time point when an amount of carbon monoxide generated during cooking decreases to a minimum value, after the amount of generated carbon monoxide increases to a maximum value.

However, in fact, it is difficult and meaningless to detect and check an entire amount of carbon monoxide generated in the cooking compartment 101.

In the present disclosure, a concentration of carbon monoxide included in the flow F of air discharged from the cooking compartment 101 is measured, and a change in the amount of generated carbon monoxide is estimated indirectly based on a change in the concentration of carbon monoxide.

Specifically, a time point when a concentration of carbon monoxide reaches maximum value, and a time point when the concentration of carbon monoxide reaches a minimum value after the time point when the concentration of carbon monoxide reaches the maximum value are specified by using the gas sensor 401, to determine whether overcooking occurs.

FIGS. 7 to 10 are graphs showing a change in the concentrations of carbon monoxide, measured by the gas sensor 401 during cooking of the cooking apparatus 1 of one embodiment.

As illustrated, a change in the concentration values of generated carbon monoxide varies obviously depending on the sort of a food item.

However, the changes in the concentration values in the graphs commonly and generally show that a concentration value of carbon monoxide reaches a minimum value after reaching a maximum value, and tend to increase after reaching the minimum value.

Additionally, it turned out that overcooking occurs at a time point when a concentration value of carbon monoxide reaches a minimum value after reaching a maximum value, as described above.

Based on this, a method for determining or judging whether a food item is cooked completely or overcooked, regardless of the sort of a food item to be cooked is specifically described hereinafter.

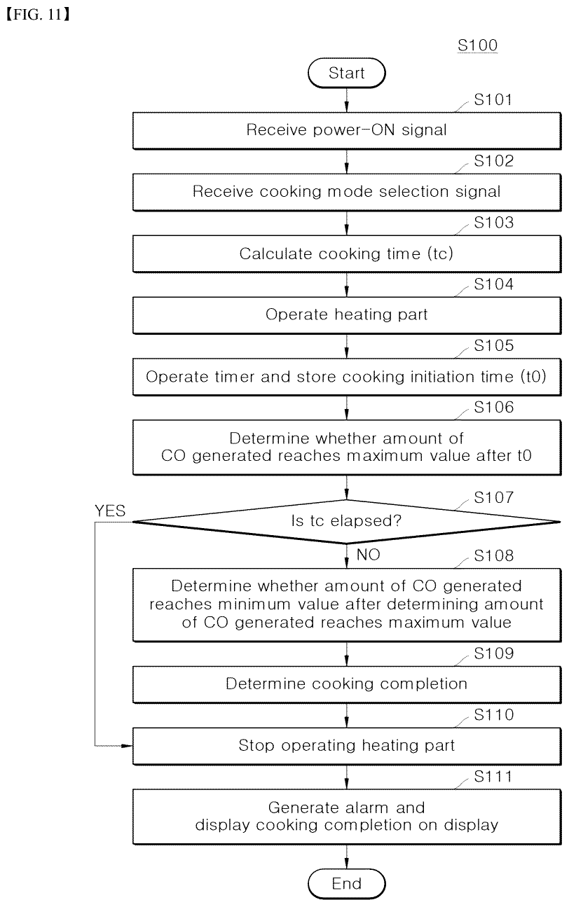

Referring to FIG. 11, the controller 600 may receive a power-ON signal of the user through the power button 8021 (S101), and receive a cooking mode selection signal of the user through the selection button 8022 or the knob 8023. (S102)

The cooking mode selection signal may comprise information on the sort and weight of a food item to be cooked.

As described above, the power-ON signal and the cooking mode selection signal may be received remotely through the user mobile device 2.

Then the controller 600 calculates predicted cooking time tc based on the selected cooking mode, the sort and weight of a food item, and transmit the predicted cooking time tc calculated to the display part 801 or the mobile device 2. (S103)

At this time, the predicted cooking time tc calculated may be temporarily stored in the memory 601.

Then power is supplied to a heating part to operate the heating part, and cooking of a food item is initiated in the selected cooking mode. (S104)

As the cooking of the food item is initiated, the controller 600 operates the timer 602 and temporarily stores cooking initiation time to when cooking is initiated in the memory 601. (S105)

Then the controller 600 monitors an amount of generated carbon monoxide after the cooking initiation time t0, and determines whether the amount of generated carbon monoxide reaches a maximum value. (S106)

At this time, the amount of generated carbon monoxide, as described above, may be indirectly estimated based on a concentration of carbon monoxide included in the flow F of air discharged from the cooking compartment 101.

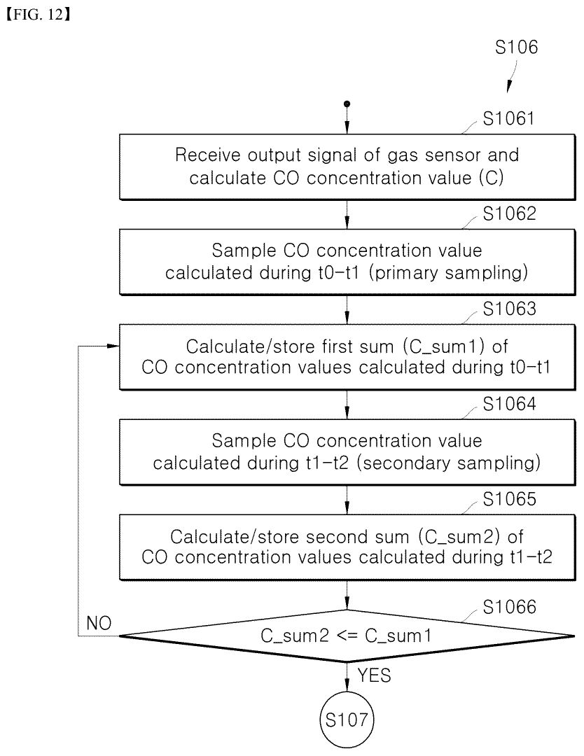

Specifically, as illustrated in FIG. 12, to see if the amount of generated carbon monoxide reaches a maximum value, the controller 600 may receive an output signal of the gas sensor 401, and based on the output signal, calculate a concentration value of carbon monoxide included in the flow F of current air. (S1061)

Then the controller 600 performs primary sampling of concentration values calculated while a first time point t1 arrives after the cooking initiation time to. (S1062) That is, the controller 600 performs the primary sampling of the concentration values calculated during first time (t0 to t1).

The primarily sampled concentration values of carbon monoxide may be temporarily stored in the memory 601.

Herein, the first time may be 2 to 3 minutes, preferably.

At this time, a primary sampling cycle in which the primary sampling is performed may be less than the first time, preferably, 5 to 10 seconds.

For example, the sampling may be performed in such a way that a concentration value of carbon monoxide is selected based on a 5-second cycle, with respect to concentration values of carbon monoxide that are calculated for 2 minutes.

That is, since the calculation is performed with respect to sampled concentration values rather than entire concentration values calculated during the first time t1, the calculation may be simplified, and an amount of data to be stored in the memory 601 may be minimized.

Then the controller 600 adds and calculates the concentration values of carbon monoxide sampled while the first time point t1 arrives after the cooking initiation time to, and stores the added and calculated concentration value as a first sum C_sum1 in the memory 601. (S1063) That is, the first sum C_sum1 of the concentration values of carbon monoxide sampled during the first time (t0 to t1) is calculated.

Then the controller performs secondary sampling of concentration values calculated while a second time point t2 arrives after the first time point t1. (S1064) That is, the controller 600 performs the secondary sampling of the concentration values calculated during second time (t1 to t2).

Likewise, the secondarily sampled concentration values of carbon monoxide may be temporarily stored in the memory 601.

Herein, like the first time, the second time may be 2 to 3 minutes, preferably.

The sampling cycle of the secondary sampling may be the same as that of the primary sampling, preferably, 5 to 10 seconds.

Then the controller 600 adds and calculates the concentration values of carbon monoxide sampled while the second time point t2 arrives after the first time point t1, and stores the added and calculated concentration value as a second sum C_sum3 in the memory 601. (S1065) That is, the second sum C_sum2 of the concentration values of carbon monoxide sampled during the second time (t1 to t2) is calculated.

As the calculations of the first sum C_sum1 and the second sum C_sum2 are completed as described above, the controller 600 calls the first sum C_sum1 and the second sum C_sum2 stored from the memory 601 and compares the first sum C_sum1 and the second sum C_sum2 to determine which one is greater than the other. (S1066)

When determining that the second sum C_sum2 is less than or the same as the first sum C_sum1, the controller 600 proceeds with the following step.

That is, when determining that the second sum C_sum2 is less than or the same as the first sum C_sum1, it may be estimated that an amount of carbon monoxide generated in the cooking compartment 101 has already reached a maximum value. When it is estimated that the amount of carbon monoxide generated reaches the maximum value, a step of determining whether the amount of carbon monoxide generated reaches a minimum value may proceed.

When the controller determines that the second sum C_sum2 is greater than the first sum C_sum1 in step 1066 described above, an amount of carbon monoxide generated has not reached the maximum value yet, and the controller returns to step 1063 and repeats the following steps.

When determining that the second sum C_sum2 is less than or the same as the first sum C_sum1 in step 1066 described above, the controller 600 determines whether time elapsed after the cooking initiation time to is greater than the predicted cooking time tc described above. (S107)

In the case where the controller 600 determines that the time elapsed after the cooking initiation time to is greater than the predicted cooking time tc described above, the controller 600 ends cooking depending on a selected cooking mode and stops operating the heating part. (S110)

In the case where the controller 600 determines that the time elapsed after the cooking initiation time to is less than the predicted cooking time tc described above, the controller 600 performs a step of determining whether an amount of generated carbon monoxide reaches a minimum value after the amount of generated carbon monoxide reaches a maximum value. (S108)

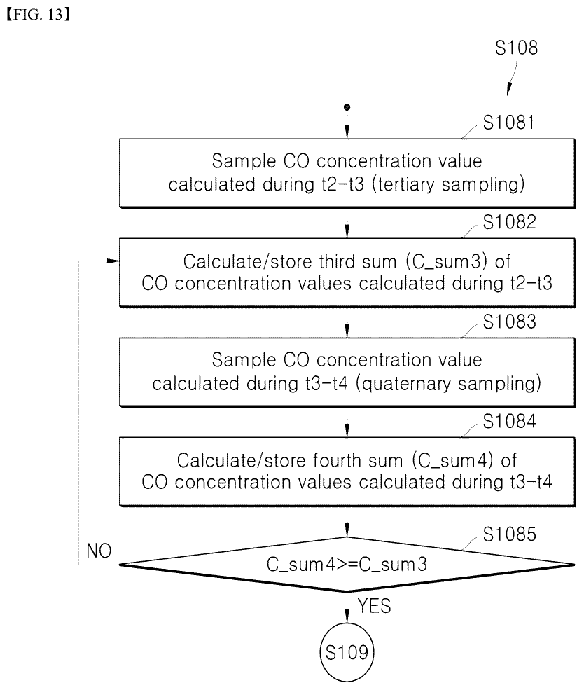

Specifically, to determine whether the amount of generated carbon monoxide reaches a minimum value, the controller 600, as illustrated in FIG. 13, performs tertiary sampling of concentration values calculated while a third time point t3 arrives after the second time point t2. (S1081)

That is, That is, the controller 600 performs the tertiary sampling of the concentration values calculated during third time (t2 to t3).

The tertiarily sampled concentration values of carbon monoxide may be temporarily stored in the memory 601.

Preferably, third time may be 1 to 2 minutes that is less than the first time and the second time described above. That is, to accurately specify the time point where an amount of generated carbon monoxide reaches a minimum value, in other words, the time point when a food item is cooked completely, the third time may be set to time that is less than the first time and the second time.

At this time, the secondary sampling cycle in which the tertiarily sampling proceeds may be less than the third time, and preferably, may be 3 to 5 seconds that is less than the primary sampling cycle described above.

The secondary sampling cycle is set to time less than the primary sampling cycle, for the same reason that the third time is less than the first time and the second time as described above.

Then the controller 600 adds and calculates the concentration values of carbon monoxide sampled while the third time point t3 arrives after the second time point t2, and stores the added and calculated concentration value as a third sum C_sum3 in the memory 601. (S1082) That is, the third sum C_sum3 of the concentration values of carbon monoxide sampled during the third time (t2 to t3) is calculated.

Then the controller performs quarternary sampling of concentration values calculated while a fourth time point t4 arrives after the third time point t3. (S S1083) That is, the controller 600 performs the quarternary sampling of the concentration values calculated during fourth time (t3 to t4).

Likewise, the quarternarily sampled concentration values of carbon monoxide may be temporarily stored in the memory 601.

Preferably, the fourth time may be 1 to 2 minutes that is the same as the third time.

The sampling cycle in which the quarternary sampling proceeds may be the same as that of the secondary sampling cycle, and preferably, may be 3 to 5 seconds.

Then the controller 600 adds and calculates the concentration values of carbon monoxide sampled while the fourth time point t4 arrives after the third time point t3, and stores the added and calculated concentration value as a fourth sum C_sum4 in the memory 601. (S1084) That is, the fourth sum C_sum4 of the concentration values of carbon monoxide sampled during the fourth time (t3 to t4) is calculated.

As the calculations of the third sum C_sum3 and the fourth sum C_sum4 are completed as described above, the controller 600 calls the third sum C_sum3 and the fourth sum C_sum4 stored from the memory 601 and compares the third sum C_sum3 and the fourth sum C_sum4 to determine which one is greater than the other. (S1085)

When determining that the fourth sum C_sum4 is greater than or the same as the third sum C_sum3, the controller 600 proceeds with the following step.

That is, when determining that the fourth sum C_sum4 is greater than or the same as the third sum C_sum3, it may be estimated that an amount of carbon monoxide generated in the cooking compartment 101 has already reached a minimum value. When it is estimated that the amount of carbon monoxide generated reaches the minimum value, the controller 600 determines that a food item is cooked completely or overcooked. (S109)

When determining that the food item is cooked completely or overcooked, the controller 600 may stop operating the heating art even before the predicted cooking time tc described above is elapsed (S110), and generate a sound alarm or a voice alarm informing that a food item is cooked completely through the sound output part 900, and display a message informing that cooking is completed through the display part 801. (S111)

When determining that the fourth sum C_sum4 is less than the third sum C_sum3 in step 1085 described above, the controller determines that an amount of generated carbon monoxide has not yet reached a minimum value, returns to step 1082 described above and repeats the following steps.

That is, in the control method of the present disclosure, since the calculation is performed with respect to sampled concentration values rather than entire calculated concentration values, the calculation may be simplified, and an amount of data to be stored in the memory 601 may be minimized.

Additionally, in the control method of the present disclosure, overcooking is determined based on comparison and determination of an added value of concentration values at each certain time interval (the first time, the second time, the third time and the fourth time) rather than a concentration value of carbon monoxide at a certain time point, thereby minimizing the effect of noise included in an output value of the gas sensor 401, and determining the occurrence of overcooking accurately.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, predictable effects based on the configurations in the disclosure are to be included within the range of the disclosure though not explicitly described in the description of the embodiment.

1.-20. (canceled)

21. A cooking apparatus, comprising:
a cavity including a cooking compartment, the cooking compartment being configured to receive a food item;
a heating part configured to generate heat to be supplied to the cooking compartment;
a gas sensor configured to sense gas generated in the cooking compartment; and
a controller configured to:
control the heating part to operate;
perform a maximum generation determination step of determining whether an amount of the gas generated reaches a maximum value, after the heating part operates;
perform a minimum generation determination step of determining whether the amount of the gas generated reaches a minimum value, after the maximum generation determination step; and
perform a cooking completion determination step of determining the food item is cooked completely when the amount of the gas generated reaches the minimum value in the minimum generation determination step.

22. The cooking apparatus of claim 21, wherein the controller is further configured to perform a heating part operation stop step of stopping operation of the heating part when determining that the food item is cooked completely in the cooking completion determination step.

23. The cooking apparatus of claim 21, wherein the maximum generation determination step further includes a concentration value calculation step of receiving, by the controller, an output signal from the gas sensor, and based on the output signal received, calculating a concentration value of the gas generated.

24. The cooking apparatus of claim 23, wherein the maximum generation determination step further includes:
a first sum calculation step of adding concentration values that are calculated while a first time is elapsed after the heating part initially operates to calculate a first sum;
a second sum calculation step of adding concentration values that are calculated while second time is elapsed after the first sum calculation step to calculate a second sum; and
a first sum and second sum comparison step of comparing the first sum and the second sum.

25. The cooking apparatus of claim 24, wherein the minimum generation determination step further includes:
in response to determining the first sum is greater than or equal to the second sum in the first sum and second sum comparison step, a third sum calculation step of adding concentration values that are calculated while a third time is elapsed after the second sum calculation step, to calculate a third sum;
a fourth sum calculation step of adding concentration values that are calculated while a fourth time is elapsed after the third sum calculation step, to calculate a fourth sum; and
a third sum and fourth sum comparison step of comparing the third sum and the fourth sum.

26. The cooking apparatus of claim 25, wherein in response to determining that the fourth sum is greater than or equal to the third sum in the third sum and fourth sum comparison step, the controller determines that the food item is cooked completely.

27. The cooking apparatus of claim 26, wherein the third time is the same as the fourth time.

28. The cooking apparatus of claim 26, wherein each of the first time and the second time is between 2 minutes and 3 minutes, and
wherein each of the third time and the fourth time is between 1 minute and 2 minutes.

29. The cooking apparatus of claim 25, wherein the first time is the same as the second time.

30. The cooking apparatus of claim 29, wherein each of the third time and the fourth time is less than each of the first time and the second time.

31. The cooking apparatus of claim 25, wherein concentration values added in the first sum calculation step and the concentration vales added in the second sum calculation step are calculated by adding concentration values sampled in a first sampling cycle, and
wherein the first sampling cycle is less than both the first time and the second time.

32. The cooking apparatus of claim 31, wherein concentration values added in the third sum calculation step and the fourth sum calculation step are calculated by adding concentration values sampled in a second sampling cycle, and
wherein the second sampling cycle is less than both the third time and the fourth time.

33. The cooking apparatus of claim 32, wherein the first sampling cycle is between 5 and 10 seconds, and
wherein the second sampling cycle is between 3 and 5 seconds.

34. The cooking apparatus of claim 32, wherein the first sampling cycle is greater than the second sampling cycle.

35. A method for controlling a cooking apparatus including a cavity including a cooking compartment configured to receive a food item, a heating part configured to generate heat to be supplied to the cooking compartment, a gas sensor configured to sense gas generated in the cooking compartment, and a controller, the method comprising:
a maximum generation determination step of determining, by the controller, whether an amount of the gas generated reaches a maximum value after the heating part operates; then
a minimum generation determination step of determining, by the controller, whether the amount of the gas generated reaches a minimum value; and then
a cooking completion determination step of determining, by the controller, that the food item is cooked completely when the amount of the gas generated reaches the minimum value in the minimum generation determination step.

36. The method of claim 35, wherein the method further comprises a heating part operation stop step of stopping operation of the heating part, by the controller, when it is determined that the food item is cooked completely in the cooking completion determination step.

37. The method of claim 35, wherein the maximum generation determination step comprises a concentration value calculation step of receiving, by the controller, an output signal from the gas sensor, and based on the output signal received, calculating, by the controller, a concentration value of the gas.

38. The method of claim 37, wherein the maximum generation determination step further comprises:
a first sum calculation step of adding concentration values that are calculated while a first time is elapsed after the heating part initially operates to calculate a first sum;
a second sum calculation step of adding concentration values that are calculated while a second time is elapsed after the first sum calculation step to calculate a second sum; and
a first sum and second sum comparison step of comparing the first sum and the second sum.

39. The method of claim 38, wherein the minimum generation determination step further includes:
in response to determining that the first sum is greater than or equal to the second sum in the first sum and second sum comparison step, a third sum calculation step of adding concentration values that are calculated while a third time is elapsed after the second sum calculation step, to calculate a third sum;
a fourth sum calculation step of adding concentration values that are calculated while a fourth time is elapsed after the third sum calculation step, to calculate a fourth sum; and
a third sum and fourth sum comparison step of comparing the third sum and the fourth sum.

40. The method of claim 39, in response to determining that the fourth sum is greater than or equal to the third sum in the third sum and fourth sum comparison step, determining, by the controller, that the food item is cooked completely.
